(19) United States
(12) Patent Application Publication
(10) Pub. No.: US 2011/0286049 A1
(43) Pub. Date: Nov. 24, 2011

(54) IMAGE READING APPARATUS

(75) Inventor: Shinya Ishikawa, Kawasaki-shi (JP)

(73) Assignee: CANON KABUSHIKI KAISHA, Tokyo (JP)

(21) Appl. No.: 13/104,384

(22) Filed: May 10, 2011

(30) Foreign Application Priority Data
May 19, 2010 (JP) 2010-115620

(51) Int. Cl. H04N 1/04

(52) U.S. Cl. 358/474

(57) ABSTRACT

An image reading apparatus includes a sensor and a control unit. The sensor includes including a photoelectric conversion unit configured to generate a charge, a first transfer unit configured to transfer the generated charge from the to an output unit, and the output unit transfers the charge to an outside of the sensor, and a second transfer unit configured to transfer the charge from the first transfer unit to a drain unit to drain the charge. The control unit configured to execute control for transferring the charge to the drain unit after transferring the charge outside the sensor, based on a size of document to be read.

### BACKGROUND OF THE INVENTION

1. Field of the Invention

The present invention relates to an image reading apparatus that includes photoelectric conversion elements, and a control method thereof.

2. Description of the Related Art

A sensor (line sensor) that includes photoelectric conversion elements transfers charges from a photoelectric conversion unit to a transfer unit, and then outputs the charges via the transfer unit. Japanese Patent Application Laid-Open No. 2000-69252 discusses a configuration in which, to increase the movement speed of a sensor when the sensor reads a document, the sensor transfer unit is split into three blocks. The charges from each of the blocks are output to a respectively-provided amplifier. Further, charges that are not necessary for reading are discarded to a charge discard drain.

An example will now be described in which a 216 mm-long sensor reads a document having a size that is smaller than the sensor length, such as when the sensor reads a business card (length 90 mm, width 55 mm), for example. In this case, for each line, a 90 mm signal charge corresponding to the document and a 126 mm signal charge (=216-90) for the pixels not relating to the document have to be output. In the configuration discussed in Japanese Patent Application Laid-Open No. 2000-69252, although the transfer unit is split into three blocks, each of which is controlled, recent sensors have several thousands of pixels and the processing circuit of the signals output from the sensor is complex, so that the circuit size increases.

### SUMMARY OF THE INVENTION

The present invention is directed to an image reading apparatus which has a simple circuit configuration and which enables a document with a narrow width to be read at a high speed.

According to an aspect of the present invention, An image reading apparatus comprising: a sensor including a photoelectric conversion unit in which a plurality of photoelectric conversion elements are arranged in a predetermined direction, an output unit configured to transfer a charge generated by the photoelectric conversion unit to an outside of the sensor, a first transfer unit configured to transfer the charge from the photoelectric conversion unit to the output unit based on a pulse signal, a drain unit configured to drain a charge, and a second transfer unit configured to transfer a charge from the first transfer unit to the drain unit; and a control unit configured to execute control for transferring a charge held by the first transfer unit to the drain unit by the second transfer unit after transferring the charge outside the sensor by first transfer unit, based on a size of document to be read.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a sensor according to a first exemplary embodiment.

FIG. 2 is a timing chart illustrating operation of a sensor according to a first exemplary embodiment.

FIG. 3 is a timing chart illustrating operation of a sensor according to a first exemplary embodiment.

FIG. 4 is a flowchart illustrating control of a sensor according to a first exemplary embodiment.

FIG. 5 is a flowchart illustrating control of a sensor according to a first exemplary embodiment.

FIG. 6 illustrates a reading range of a sensor according to an exemplary embodiment.

FIG. 7 illustrates a configuration of a sensor according to a second exemplary embodiment.

FIG. 8 is a timing chart illustrating operation of a sensor according to a second exemplary embodiment.

FIG. 9 is a flowchart illustrating control of a sensor according to a second exemplary embodiment.

FIG. 10 is a flowchart illustrating reading control according to a third exemplary embodiment.

FIG. 11 illustrates an image read by a reading preparation operation according to a third exemplary embodiment.

FIG. 12 is a perspective view of a multifunction printer.

FIG. 13 is a plan view and a cross-sectional view of an image reading apparatus.

FIG. 14 illustrates the control blocks in a multifunction printer.

### DESCRIPTION OF THE EMBODIMENTS

Various exemplary embodiments, features, and aspects of the invention will be described in detail below with reference to the drawings.

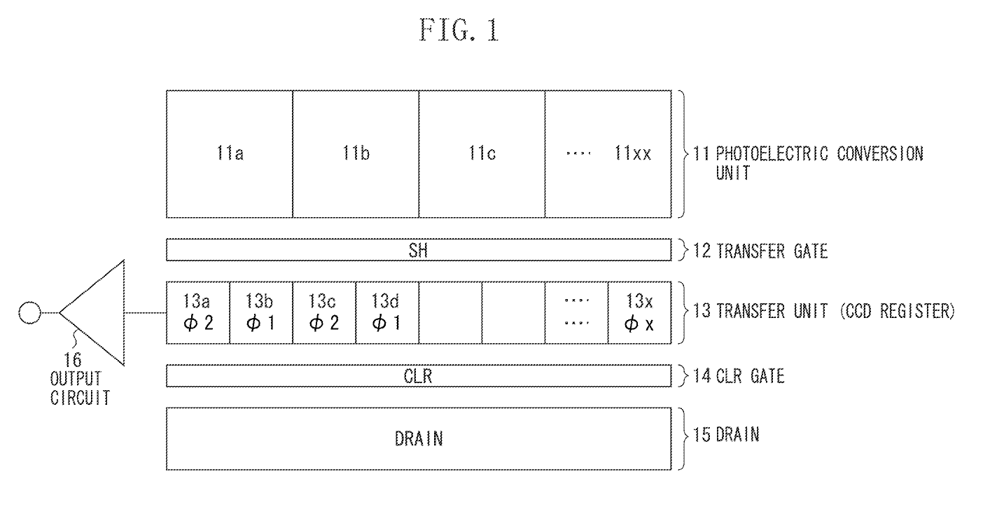

FIG. 1 illustrates a configuration of a sensor according to a first exemplary embodiment. A sensor (line sensor) includes a photoelectric conversion unit 11, a transfer unit 13, a transfer gate 12, a clear gate (CLR gate) 14, a drain 15, and an output circuit (unit) 16. The photoelectric conversion unit 11 is configured from a plurality of photoelectric conversion elements 11a, 11b, . . . , 11xx, which are arranged in a straight line in a predetermined direction, and which generate a signal charge by photoelectric conversion of light. The transfer unit 13 transfers charges to the output circuit 16. The transfer unit 13 is configured from transfer members 13a, 13b, 13×, which are arranged along the array of photoelectric conversion elements. The transfer gate 12 transfers the charges generated by the photoelectric conversion unit 11 to the transfer unit 13. The transfer gate 12 is arranged between the photoelectric conversion unit 11 and the transfer unit 13. The drain 15 discards unnecessary charges. The drain (charge deletion unit, charge discard unit) 15 is arranged parallel to the transfer unit 13. The clear gate (CLR gate) 14 controls the transfer of charges from the transfer unit 13 to the drain 15. The clear gate (CLR gate) 14 is arranged between the transfer unit 13 and the drain 15. Charges transferred from the transfer unit 13 to the drain 15 are discarded by the drain 15. The output unit 16 transfers a charge generated by the photoelectric conversion unit 11 to an outside of the sensor. Charges are output from the sensor as an output signal in the form of a line via the output circuit 16. The photoelectric conversion unit 11, the transfer unit 13, the transfer gate 12, the clear gate (CLR gate) 14, and the drain 15 are arranged to line up in the direction intersecting the direction that photoelectric conversion elements are arranged.

The sensor illustrated in FIG. 1 can be executed in a first mode (a first control) or a second mode (a second control) by a control unit. The operation mode is set based on an instruction from the operation unit of a device which is configured with the sensor. For example, the operation unit includes an input unit for specifying a mode by the user. A reading operation is performed based on the set mode. The setting of this operation mode can also be performed based on a signal received from a device connected to the device configured with the sensor. For example, the first mode illustrates a case in which letter size document is read.

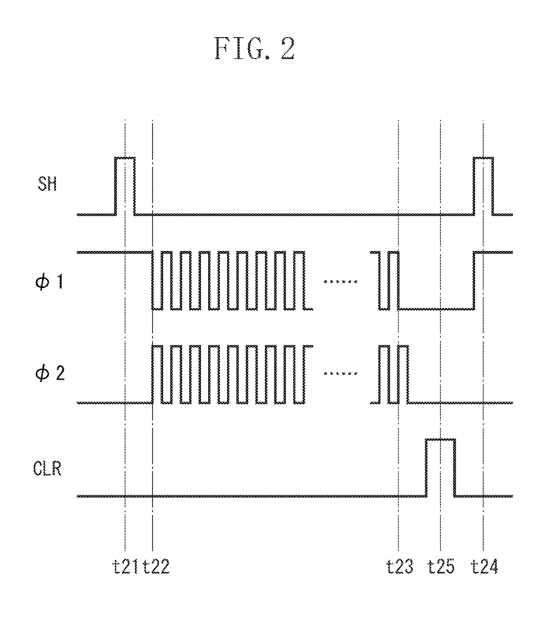

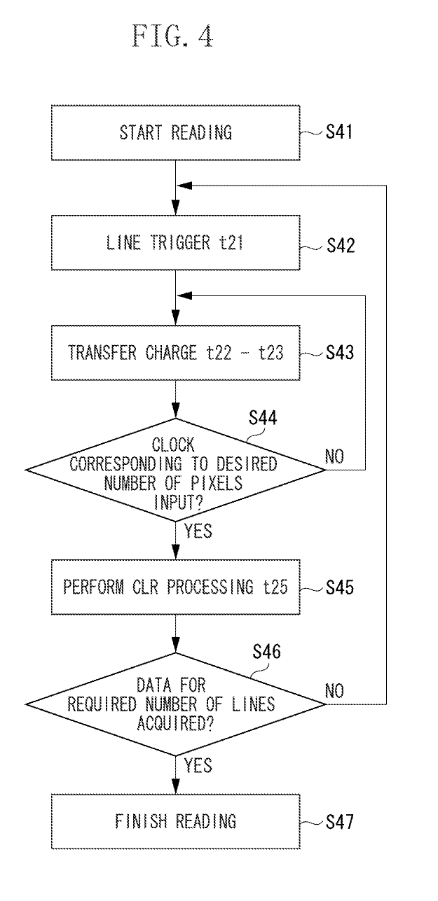

FIG. 2 illustrates the timing in the first mode. The signals in FIG. 2 drive the blocks illustrated in FIG. 1 which have the same reference numerals as FIG. 2. For example, the signal SH in FIG. 2 controls the transfer gate SH illustrated in FIG. 1. Similarly, the signal φ1 in FIG. 2 controls the φ1 of the transfer unit illustrated in FIG. 1, and the signal φ2 in FIG. 2 controls the φ2 of the transfer unit illustrated in FIG. 1. FIG. 4 illustrates a control flow in the first mode. In the first mode, the charges generated by the photoelectric conversion elements (number of pixels corresponding to 216 mm) included in the sensor are output from the sensor.

The control flow illustrated in FIG. 4 will now be described. In step S41, the number of reading lines is specified, and reading is started. Then, in step S42, at a timing t21, a pulse SH (line synchronization signal) is applied to the transfer gate 12, and the charges stored by the photoelectric conversion unit 11 are transferred to the φ1 and φ2 of the transfer unit 13. For example, a charge generated by the photoelectric conversion unit 11a is transferred to 13b, a charge generated by the photoelectric conversion unit 11b is transferred to 13d. Based on this line synchronization signal, the photoelectric conversion unit 11 stores charges for the amount of one line for the period from t21 to t24. More specifically, during the period from t21 to t24, the charges in the photoelectric conversion unit 11 are stored and the charges from the transfer unit 13 are output.

After the charge transfer at t21, in step S43, the charges in the transfer unit 13 are transferred to the output circuit 16 and output as a sensor signal by applying a clock (pulse signal) from t22 to t23 to the transfer unit 13, which is configured with φ1 and φ2. Then, in step S44, it is determined whether clocks corresponding to the desired number of pixels were input to the transfer unit 13 from t22 to t23. This desired clock number is the number to output all the charges of the pixels included in the linear sensor. If the number of clocks is insufficient for the pixel number, the pixel charges that are located away from the output circuit remain in the transfer unit 13. This is because if the charges remain, the remaining charges will be superimposed with the signal charges that are transferred from the photoelectric conversion unit 11 to the transfer unit 13 by the line synchronization signal of the next line, so that a correct output signal cannot be obtained. In step S45, after the charges have been transferred based on the desired clock number, a CLR signal is applied. Then, in step S46, it is determined whether all of the data for the required number of lines has been acquired. If the number of reading lines has not yet reached required number (NO in step S46), the processing from steps S42 to S46 is repeated. If the number of reading lines has reached required number (YES in step S46), the processing proceeds to step S47. In step S47, the reading is finished. In this control, the sensor moves by the amount of number of reading line.

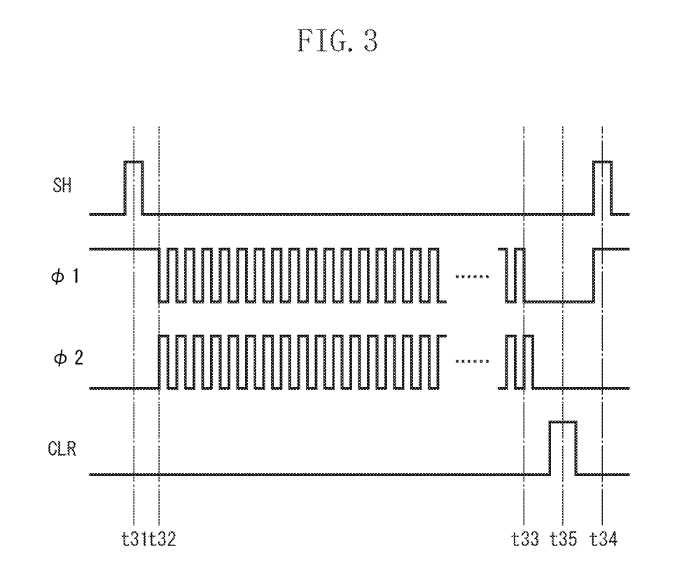

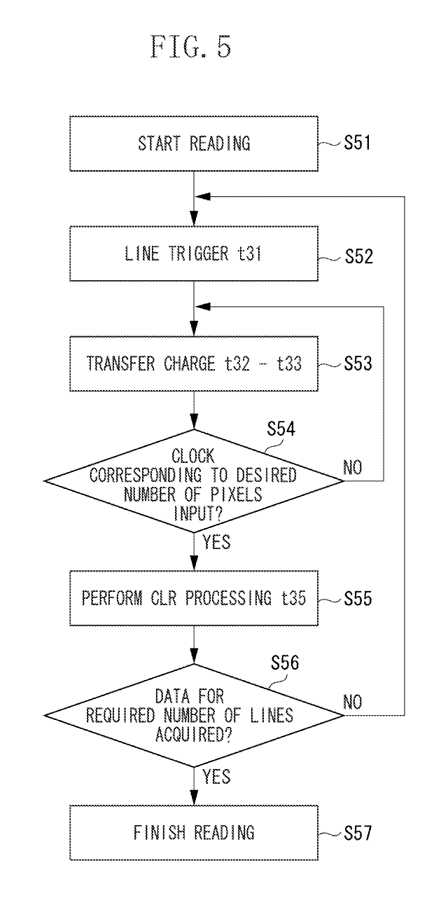

FIG. 3 illustrates the timing in the second mode. FIG. 5 illustrates a control flow in the second mode. In the second mode, the charges generated by a portion of the photoelectric conversion elements (number of pixels corresponding to 55 mm) included in the sensor are output from the sensor. The second mode illustrates a case in which a business card is read.

The control flow illustrated in FIG. 5 will now be described. Here, a description of the steps that are the same as FIG. 4 will be omitted, and only the differences will be described. The difference between FIG. 5 and FIG. 4 is that in step S54, the number of pixels that are to be determined is different. The number of pixels that are to be determined is fewer than in the first mode. In step S54, if it is determined that a predetermined number of pixels have been input (YES in step S54), the processing proceeds to step S55. Therefore, the period from the timing of the pulse SH to the last φ1 and φ2 is shorter than in FIG. 2. This indicates that the charges for one line are output from the sensor in a shorter time. Further, the control unit shortens the pulse SH interval. Consequently, the sensor movement speed can be set faster than the movement speed in the first mode. Further, in the second mode, the light emission amount of the light source is set to be greater than light emission amount in the first mode. By increasing the light emission amount, the charge amount can be increased, so that deterioration of the quality of the read image can be suppressed.

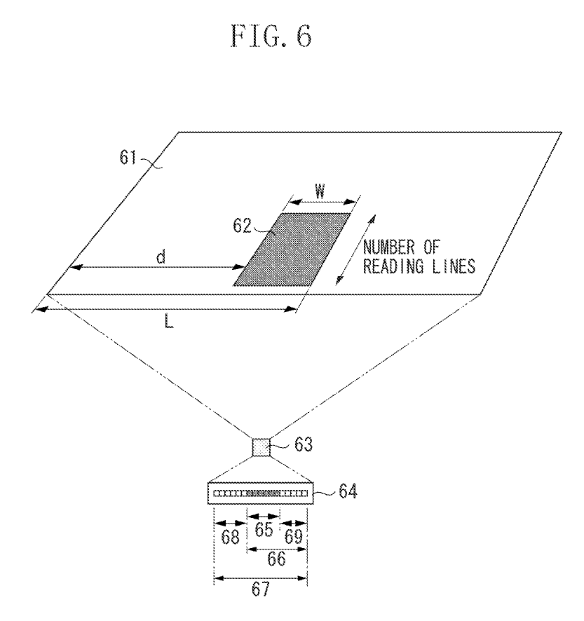

FIG. 6 illustrates the pixel number output by the sensor. In FIG. 6, a document 62, which has a width (w: 55) that is narrower than the sensor length, is arranged at a predetermined position (a position at a distance d from a reference position of the document positioning plate in the array direction of the photoelectric conversion elements). The reading of an image of the document 62 may be performed in an arbitrary manner, as long as the photoelectric conversion unit charges corresponding to a range 65 can be acquired. Therefore, in the second mode, the control unit outputs control signals (φ1 and φ2) so that photoelectric conversion unit charges corresponding to a range 66 are output. Further, in the second mode, the control unit outputs a control signal (CLR signal) so that photoelectric conversion unit charges corresponding to a range 68 are output to the drain. In contrast, in the first mode, to perform reading of an image having the same length as the sensor, the control unit outputs control signals so that photoelectric conversion unit charges corresponding to a range 67 are output.

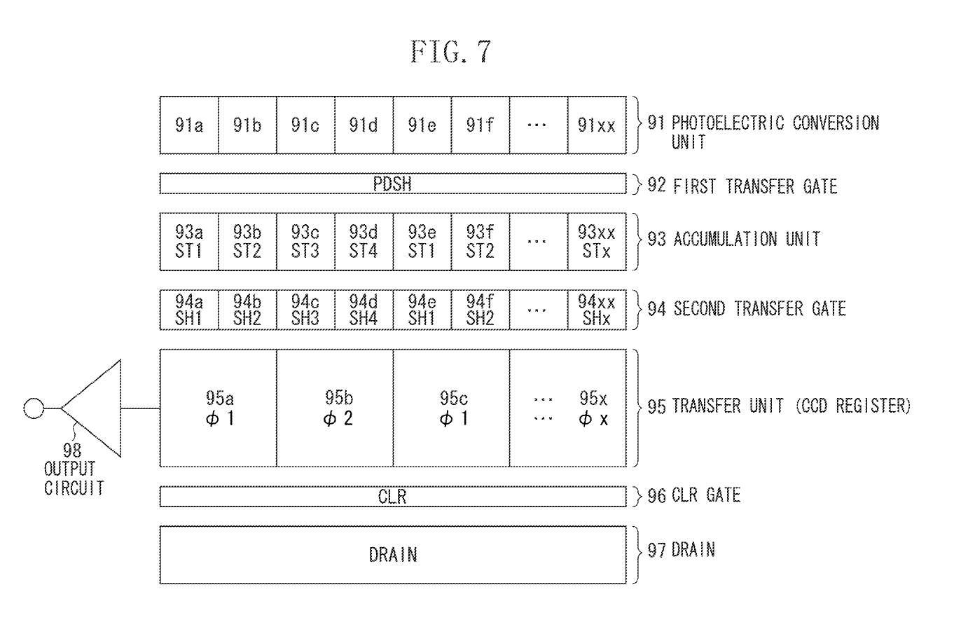

FIG. 7 illustrates a configuration of a sensor according to a second exemplary embodiment. The sensor illustrated in FIG. 7 has the same configuration as that in the first exemplary embodiment, except for having an storage unit 93 and a second transfer gate 94. The storage unit 93 includes four area types, ST1, ST2, ST3, and ST4, which are arranged in a four-pixel period, as illustrated in FIG. 7. The transfer gate 94 includes four independent gate types SH1, SH2, SH3, and SH4, which correspond to the areas in the storage unit 93. When the signal SH1 is input to the transfer gate, the charges in the area ST1 including areas 93a and 93e of the storage unit 93 corresponding to SH1 are transferred to φ1. Similarly, when the signal SH2 is input to the transfer gate, the charges in the area ST2 including areas 93b and 93f of the storage unit 93 corresponding to SH2 are transferred to φ1. Further, the charges in the area ST3 of the storage unit 93 corresponding to SH3 are transferred to φ2 based on the signal SH3, and the charges in the area ST4 of the storage unit 93 corresponding to SH4 are transferred to φ2 based on the signal SH4.

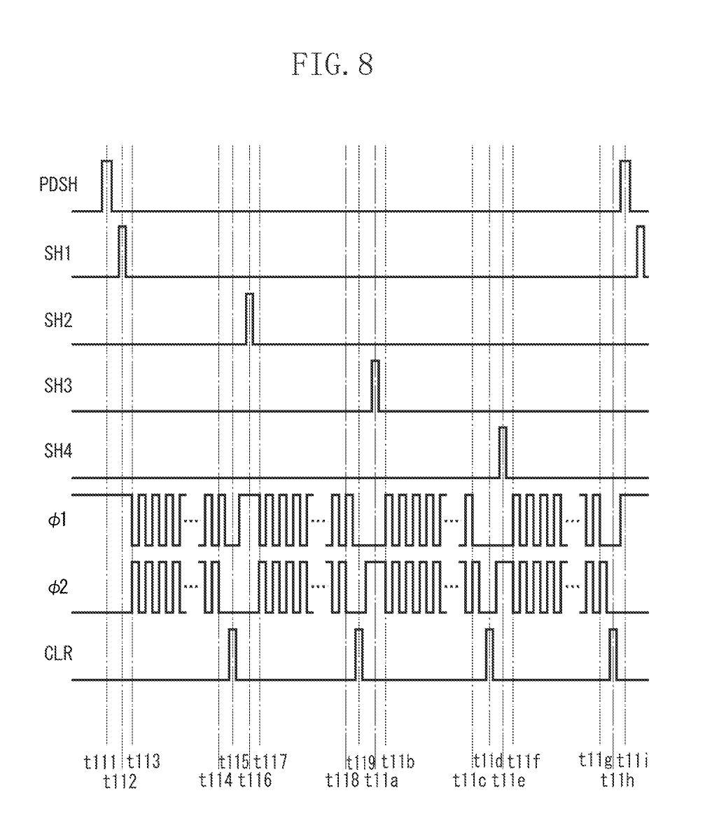

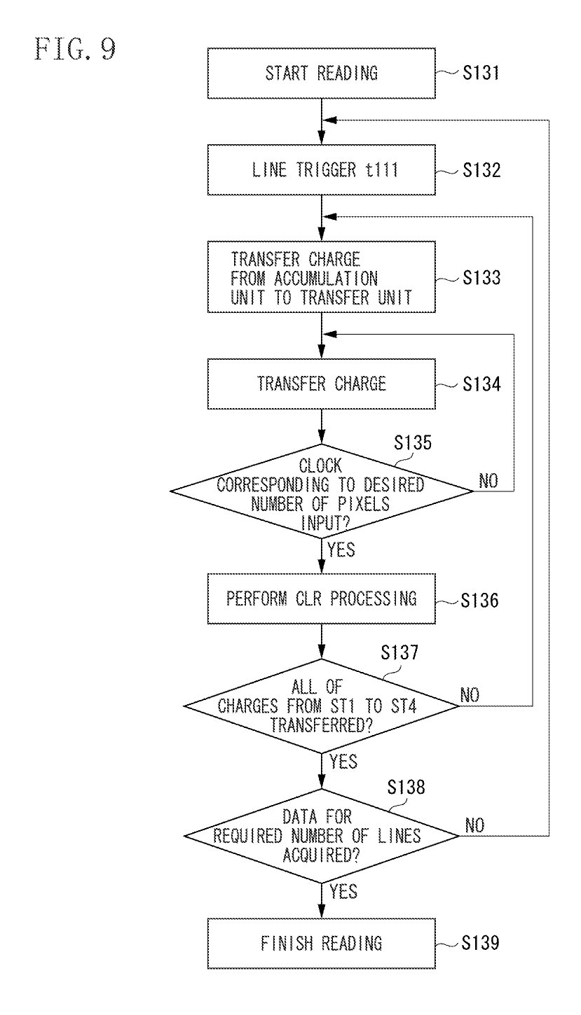

FIG. 8 illustrates the timing in the second mode. FIG. 9 illustrates the control flow in the second mode.

In step S131, the number of reading lines is specified, and reading is started. In step S132, at a timing t111, a pulse PDSH is applied to a first transfer gate 92, and the charges stored by the photoelectric conversion unit 91 are transferred to the storage unit 93. During the period from t111 to t11i, the photoelectric conversion unit stores an amount of charges for the next line. Next, in step S133, at a timing t112, a pulse SH1 is applied to a second transfer gate 94a, and the charges stored in 93a, 93e, . . . in the storage unit 93 are transferred to a transfer unit 95. In step S134, from t113 to t114 the charges in the transfer unit 95 are transferred to an output circuit 98 and output as a sensor signal by applying a pixel clock to the transfer unit 95, which is configured with φ1 and φ2. In this case, similar to the first exemplary embodiment, the number of clock applied to the transfer unit 95 corresponds to a number that enables output of the charges in the photoelectric conversion unit corresponding to the range 66.

Consequently, in step S135, it is determined whether the desired number of the pixel clocks have been applied. If it is determined that the pixel clock has been applied (YES in step S135), in step S136, CLR processing for applying a CLR signal is performed. Consequently, among the charges stored in ST1 in the storage unit 93, the charges corresponding to the range 68 are discarded to the drain. In step S137, it is determined whether the processing from ST1 to ST4 has finished. If it is determined that the processing from ST1 to ST4 has finished (YES in step S137), the processing proceeds to step S138. If it is determined that this processing has not finished (NO in step S137), the processing returns to step S133. In step S138, it is determined whether the processing of the number of reading lines has finished. If it is determined that the processing of the number of reading lines has not finished (NO in step S138), the processing returns to step S132. If it is determined that the processing of the number of reading lines has finished (YES in step S138), the processing proceeds to step S139, and the reading processing finishes.

Similar to the first exemplary embodiment, the number of clocks applied to the transfer unit 95 in the first mode corresponds to a number that enables output of the pixel charges corresponding to the range 67. Therefore, since only the pixel clock number is different, a description of the control and timing in the first mode will be omitted.

Thus, using a sensor that has a storage unit 93 and a second transfer gate 94, when reading a document 62 that is narrower in width than the sensor length, the time required for reading can be shortened than ever before by making the time interval of the pulse PDSH shorter.

In the first and second exemplary embodiments, charges in a predetermined range were output by the sensor based on the operation mode. In a third exemplary embodiment, the area of the document 62 is determined, and based on the determination result, the sensor outputs charges.

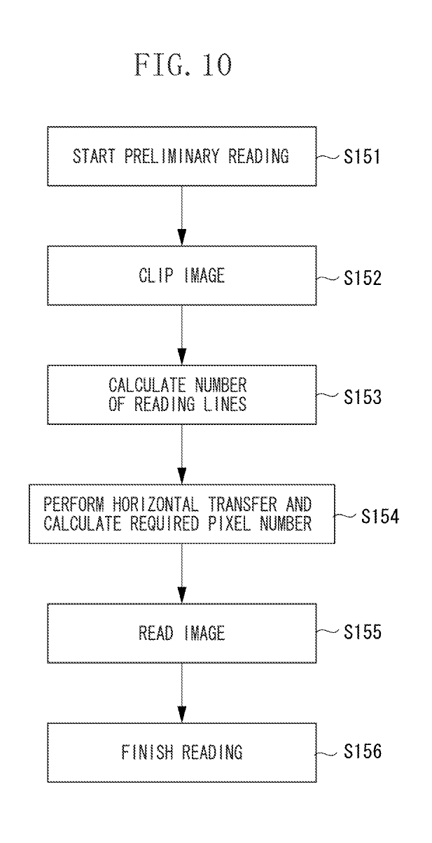

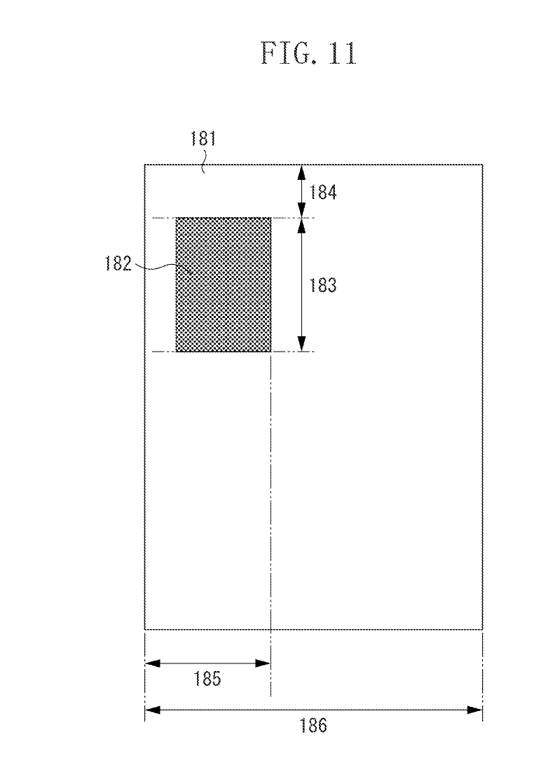

FIG. 10 illustrates an operation flow according to the third exemplary embodiment. In step S151, preliminary reading for reading the whole document positioning plate is performed. To read the whole plate, the range 67 illustrated in FIG. 6 of all the pixels of the linear sensor 64 is used. This image width is equivalent to the width of a document positioning glass plate 61. In step S152, an image corresponding to an area of the document 62 is clipped from the image obtained by the preliminary reading. FIG. 11 illustrates image data obtained by the preliminary reading. In step S153, among the image data, the number of reading lines is acquired from a document read start line number 184 and a document length line number 183. In step S154, the clipping in the pixel alignment direction (horizontal direction in FIG. 11) of the sensor is calculated based on a pixel number 185, which is from the first pixel of the sensor to the pixel at the edge of the image. These calculations can be carried out by software processing of an image read by the reading apparatus body or by a host computer operating the reading apparatus, or can be carried out or specified by the user referring to image data. In step S155, the image in the calculated area is read, and then in step S156 the reading operation is finished. Step S155 executes the second mode described in the first and second exemplary embodiments.

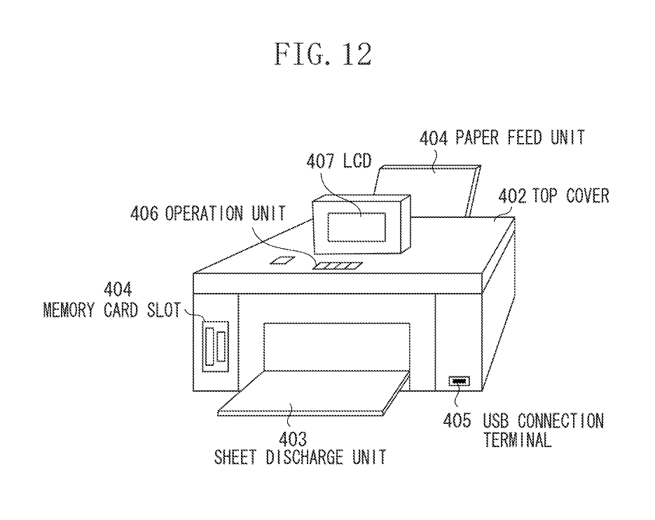

Next, the image reading apparatus will be described. FIG. 12 is a front view of the appearance of a multifunction printer (hereinafter referred to MFP) 401 that includes the sensor according to the above exemplary embodiments. The MFP 401 includes a recording unit (recording apparatus) and a scanner unit (reading apparatus). The recording unit includes an inkjet printer. The scanner unit includes a flatbed scanner provided with a sensor. Further, the scanner unit is provided on an upper portion of the recording unit in structure. The scanner unit is provided with a top cover 402 for holding down the image document. The top cover 402 can be moved rotationally on a hinge (not illustrated). On the other hand, the recording unit is provided with a sheet discharge unit 403 for discharging a recording medium out of the apparatus after recording, and a paper feed unit 404 in which the recording medium, such as the recording sheets used in recording, is loaded.

A memory card slot 405 is arranged on the front face of the MFP 401. A memory card used for a digital camera, a personal computer and the like is mounted on the memory card slot 404. The memory card slot 404 is provided with two types of slot. In addition, an external device connection terminal (a universal serial bus (USB) interface terminal) 405 is provided on the front face of the MFP 401 for connecting with a digital camera or an external storage device.

The MFP 401 is also provided with an operation unit 406 that includes a plurality of buttons and a display unit (liquid crystal display (LCD)) 408 for menu display and image display.

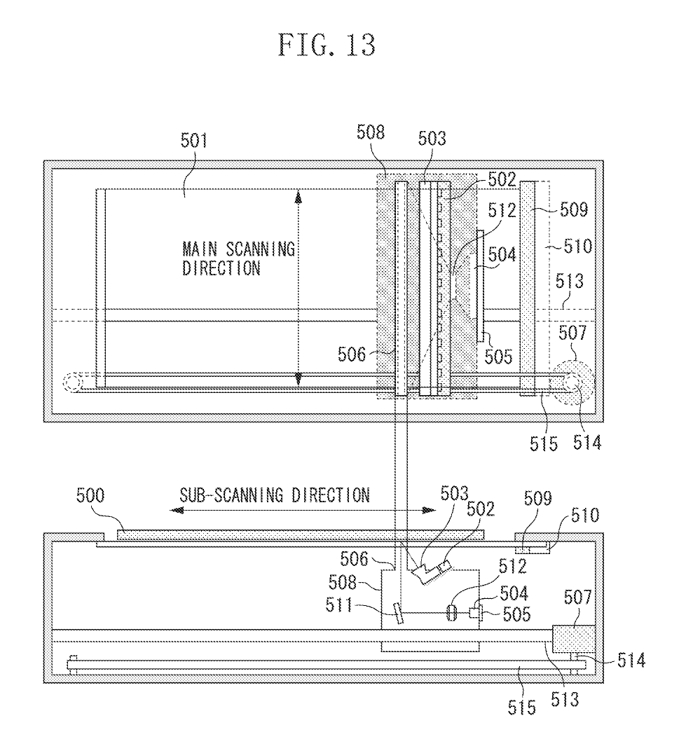

Next, the scanner unit will be described. FIG. 13 is a top view and a side view of the scanner unit. The scanner unit includes a glass plate 501, on which the document is placed, a carriage 508 and the like. The carriage 508 moves in a sub-scanning direction along a shaft 513. A carriage motor 507 serves as a drive source for the scanner carriage 508. Further, the scanner carriage 508 is configured with, for example, a light source (LED) 502 for emitting light, a light guide 503 for guiding the emitted light to a document 500, a mirror 511 for guiding the light reflected on the document 500 to a sensor 504, and a lens 512.

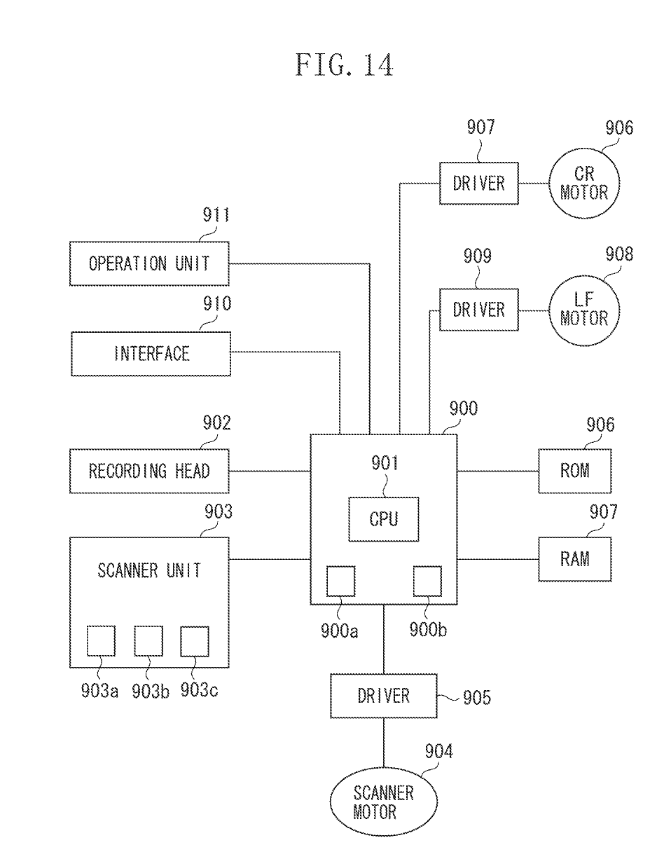

Next, the control configuration of the multifunction printer will be described. FIG. 14 illustrates the control blocks of the multifunction printer. A controller 900 includes a central processing unit (CPU) 901, and controls the recording unit (recording apparatus) and the scanner unit (recording apparatus). Specifically, the controller 900 controls a recording head 902, a scanner unit 903, and the drive of various motors (906, and 908). The CPU 901 executes the above controls based on a control program and a data table stored in a read-only memory (ROM) 906. The RAM 907 includes work RAM used by CPU 901. The CPU 901 performs control by receiving a signal from an operation unit 911 and an interface 910.

The CPU 901 executes the above-described high-resolution mode or low resolution mode in control by of the scanner unit (reading apparatus). The controller 900 transfers the various signals to the scanner unit 903 and inputs image signals from the scanner unit 903. An analog/digital (A/D) conversion circuit 903C inputs analog signals from a sensor 903b. The analog/digital (A/D) conversion circuit 903C converts analog signals into digital signals, and transfers the digital signals to an image processing circuit (image processing unit 900a). The digital signals are subjected to image processing by the image processing unit, and the resultant data is stored in a memory. A signal generation unit 900b generates various signals, and outputs the generated signals to the scanner unit 903. The image processing unit deletes, for example, the data for the range 69 illustrated in FIG. 6 in the second mode. The controller 900 also includes a recording data generation unit for generating recording data for output to the recording head in control of the recording unit (recording apparatus).

The scanner unit 903 includes a signal generation circuit or a control circuit (control unit) which generates a signal for driving the sensor based on a signal input from the controller 900. This signal generation circuit or control circuit may also be provided in the sensor.

The scanner section 903 also includes a light emitting unit (irradiation unit) 903a that includes a light emitting element, such as a LED 502 (FIG. 13). The document is irradiated with light from the light emitting unit (irradiation unit), and the reflected light is received by the sensor 903b. The sensor 903b corresponds to sensor in FIG. 1. The sensor 903b corresponds to sensor 504 in FIG. 13.

Although the device including the sensor was described using a multifunction printer as an example, the device including the sensor may be an image recording apparatus that only includes a reading unit (reading function). Further, the number of photoelectric conversion elements provided in the sensor and the number of lines of photoelectric conversion element arrays is not limited. In addition, the position where the document is positioned on the document positioning plate is not limited to the example illustrated in FIG. 6.

Further, although the first mode was described using a case in which letter size document is read, the first mode may also be applied in A4 size document. Further, although the second mode was described using a case in which a business card is read, the second mode may also be applied in reading a film. In this case, the sensor is controlled so that a range corresponding to the film size is read. Further, the light emission amount of the light source is set to a value corresponding to the film.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-115620 filed May 19, 2010, which is hereby incorporated by reference herein in its entirety.

1. An apparatus comprising:
a sensor including
a photoelectric conversion unit in which a plurality of photoelectric conversion elements are arranged in a predetermined direction,
an output unit configured to transfer a charge generated by the photoelectric conversion unit to an outside of the sensor,
a first transfer unit configured to transfer the generated charge to the output unit based on a pulse signal,
a drain unit configured to drain the charge, and
a second transfer unit configured to transfer the charge from the first transfer unit to the drain unit; and
a control unit configured to execute control for transferring the charge to the drain unit after transferring the charge outside the sensor, based on a size of document to be read.

2. The apparatus according to claim 1, further comprising a light source,
wherein the control unit sets a light amount for a second control to be greater than a light amount for a first control.

3. The apparatus according to claim 1, further comprising a third transfer unit configured to transfer a charge to the first transfer unit from the photoelectric conversion unit.

4. The apparatus according to claim 1, further comprising an storage unit located between the photoelectric conversion unit and the first transfer unit.
